(19) United States
(12) Patent Application Publication
(10) Pub. No.: US 2025/0222356 A1
(43) Pub. Date: Jul. 10, 2025

(54) PROGRAM, PROCESSING APPARATUS, AND PROCESSING METHOD

(71) Applicant: CYGAMES, INC., Tokyo (JP)

(72) Inventors: Iwaki Ikeda, Tokyo (JP); Daigo Nakamura, Tokyo (JP)

(73) Assignee: CYGAMES, INC., Tokyo (JP)

(21) Appl. No.: 19/090,018

(22) Filed: Mar. 25, 2025

Related U.S. Application Data
(63) Continuation of application No. PCT/JP2023/035588, filed on Sep. 29, 2023.

(30) Foreign Application Priority Data
Sep. 30, 2022 (JP) 2022-157621

(51) Int. Cl. A63F 13/54; G06F 3/16

(52) U.S. Cl. CPC A63F 13/54; G06F 3/165; A63F 2300/638

(57) ABSTRACT

A program causes a computer to function as: an output sound manager that manages management information in which identification information for identifying an output sound being output at a current time point and information indicating an output start timing of the output sound are associated with each other; a caller that calls an event of controlling the output sound; a determination unit that determines the output sound to be newly output; a calculator that calculates details of volume adjustment to be performed for the output sound being output at the current time point, based on a time difference between the output start timing of the output sound being output at the current time point and the current time point; and an output sound controller that outputs the output sound determined to be newly output, and adjust the output sound being output at the current time point.

### TECHNICAL FIELD

The present invention relates to a program, a processing apparatus, and a processing method.

### BACKGROUND ART

In games, multiple output sounds such as background music (BGM), sound effects, and dialogue may be simultaneously output. Entertainability and the like of games is enhanced by simultaneously outputting multiple output sounds. However, when multiple output sounds are simultaneously output, an inconvenience such as an important output sound being canceled by another output sound may occur. As one means for solving the inconvenience, ducking processing is known. As described in Patent Document 1, in the ducking processing, when an important output sound is output, the volume of another output sound is decreased to accentuate the important output sound.

### CITATION LIST

### Patent Literature

Patent Document 1: JP 2017-220798 A

### SUMMARY OF INVENTION

### Technical Problem

In a case of the ducking processing, a problem exists in that when two or more important output sounds are simultaneously output, the output sounds may decrease one another's volume due to an increase in peak or RMS thereof. The problem to be solved by the present invention is to perform control to further accentuate a more important output sound when multiple output sounds are simultaneously output.

### Solution to Problem

According to an aspect of the present invention, provided is a program causing a computer to function as:
an output sound manager configured to manage management information in which identification information for identifying one or multiple output sounds being output at a current time point and information indicating an output start timing of each of the one or multiple output sounds are associated with each other;
a caller configured to call an event of controlling the output sound;
a determination unit configured to, based on the event, determine the output sound to be newly output;
a calculator configured to, based on the event, calculate details of volume adjustment to be performed for each of the one or multiple output sounds being output at the current time point, based on a time difference between the output start timing of each of the one or multiple output sounds being output at the current time point and the current time point; and
an output sound controller configured to output the output sound determined to be newly output, and adjust each of the one or multiple output sounds being output at the current time point, based on the calculated details of the volume adjustment.

According to an aspect of the present invention, provided is a processing apparatus including:
an output sound manager configured to manage management information in which identification information for identifying one or multiple output sounds being output at a current time point and information indicating an output start timing of each of the one or multiple output sounds are associated with each other;
a caller configured to call an event of controlling the output sound;
a determination unit configured to, based on the event, determine the output sound to be newly output;
a calculator configured to, based on the event, calculate details of volume adjustment to be performed for each of the one or multiple output sounds being output at the current time point, based on a time difference between the output start timing of each of the one or multiple output sounds being output at the current time point and the current time point; and
an output sound controller configured to output the output sound determined to be newly output, and adjust each of the one or multiple output sounds being output at the current time point, based on the calculated details of the volume adjustment.

According to an aspect of the present invention, provided is a processing method performed by one or more computers, the processing method including:
managing management information in which identification information for identifying one or multiple output sounds being output at a current time point and information indicating an output start timing of each of the one or multiple output sounds are associated with each other;
calling an event of controlling the output sound;
based on the event, determining the output sound to be newly output;
based on the event, calculating details of volume adjustment to be performed for each of the one or multiple output sounds being output at the current time point, based on a time difference between the output start timing of each of the one or multiple output sounds being output at the current time point and the current time point; and
outputting the output sound determined to be newly output, and adjusting each of the one or multiple output sounds being output at the current time point, based on the calculated details of the volume adjustment.

### Advantageous Effects of Invention

According to an aspect of the present invention, a program, a processing apparatus, and a processing method that solve a problem to perform control to further accentuate a more important output sound when multiple output sounds are simultaneously output are implemented.

### BRIEF DESCRIPTION OF DRAWINGS

The above and other objects, features, and advantages will become more apparent in the following public embodiments and the following drawings attached thereto.

FIG. 1 is a diagram illustrating an example of a hardware configuration of a processing apparatus.

FIG. 2 is a diagram illustrating an example of a functional block diagram of the processing apparatus.

FIG. 3 is a diagram schematically illustrating an example of information processed by the processing apparatus.

FIG. 4 is a diagram schematically illustrating another example of information processed by the processing apparatus.

FIG. 5 is a diagram schematically illustrating another example of information processed by the processing apparatus.

FIG. 6 is a diagram schematically illustrating another example of information processed by the processing apparatus.

FIG. 7 is a diagram schematically illustrating another example of information processed by the processing apparatus.

FIG. 8 is a flowchart illustrating an example of a flow of processing of the processing apparatus.

### DESCRIPTION OF EMBODIMENTS

Embodiments of the present invention will be described below with reference to the drawings. Note that, in all of the drawings, similar constituent elements are denoted by similar reference signs and description thereof will be omitted as appropriate.

### First Embodiment

### Overview

As a result of studying the problem to “perform control to further accentuate a more important output sound when multiple output sounds are simultaneously output”, the inventors of the present invention have found that an output sound whose output start timing is closer to the current time point out of the multiple output sounds to be simultaneously output may be more important.

For example, when a sound of a blow (output sound) according to a blowing action is output in a situation in which background music (BGM, output sound) whose output start timing is a game start time point is playing, the sound of the blow (output sound) whose output start timing is closer to the current time point is more important at the current time point.

When first, second, and third blowing actions are consecutively performed in this order and sounds of the first, second, and third blows (output sounds) are consecutively output in this order according to the respective blowing actions, the sound of the third blow (output sound) whose output start timing is closer to the current time point is more important at the current time point.

The inventors of the present invention completed the present invention by taking this point into consideration. When the processing apparatus of the present invention outputs a new output sound, the processing apparatus decreases the volume of output sounds being output at this time point. Then, the processing apparatus determines the decrease amount of the volume, based on a time difference between the output start timing of each of the output sounds and the current time point. Specifically, the processing apparatus determines a larger decrease amount as the time difference increases. In other words, the farther the output start timing is from the current time point, the larger the amount of decrease determined is, and the closer the output start timing is to the current time point, the smaller the amount of decrease determined is.

Through such processing, an output sound whose output start timing is closer to the current time point is output at larger volume. As a result, “control of accentuating a more important output sound, that is, an output sound whose output start timing is closer to the current time point, when multiple output sounds are simultaneously output” can be performed. A configuration of the processing apparatus will be described below in detail.

### Hardware Configuration

Next, an example of a hardware configuration of the processing apparatus will be described. The processing apparatus may be a server that provides a game. Moreover, the processing apparatus may be a user terminal that is operated by a user. Examples of the user terminal include a game console, a personal computer, a tablet terminal, a smartphone, a mobile phone, and a smartwatch. Each functional unit of the processing apparatus is implemented by any combination of hardware and software, such as a central processing unit (CPU), a memory, a program loaded in the memory, a storage unit such as a hard disk that stores the program (a program stored in advance at a stage of shipment of the apparatus as well as a program downloaded from a recording medium such as a compact disc (CD), a server on the Internet, or the like can be stored), and a network connection interface of any computer. It is understood by a person skilled in the art that there are various modified examples of a method and an apparatus for the implementation.

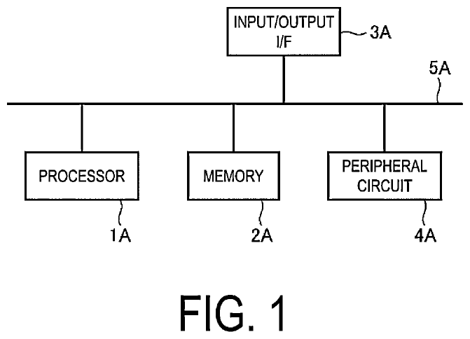

FIG. 1 is a block diagram illustrating an example of the hardware configuration of the processing apparatus. As illustrated in FIG. 1, the processing apparatus includes a processor 1A, a memory 2A, an input/output interface 3A, a peripheral circuit 4A, and a bus 5A. The peripheral circuit 4A includes various modules. The processing apparatus need not include the peripheral circuit 4A. Note that the processing apparatus may include multiple apparatuses physically and/or logically divided. In this case, each of the multiple apparatuses can include the hardware configuration described above.

The bus 5A is a data transmission path for the processor 1A, the memory 2A, the peripheral circuit 4A, and the input/output interface 3A to transmit and receive data to and from each other. The processor 1A is, for example, an arithmetic processing apparatus, such as a CPU and a graphics processing unit (GPU). The memory 2A is, for example, a memory, such as a random access memory (RAM) and a read only memory (ROM). The input/output interface 3A includes an interface for acquiring information from an input device, an external device, an external server, an external sensor, a camera, or the like, an interface for outputting information to an output device, an external device, an external server, or the like, and the like. The input device is, for example, a keyboard, a mouse, a microphone, a physical button, a touch panel, or the like. The output device is, for example, a display, a speaker, a printer, a mailer, or the like. The processor 1A can output a command to each module, and perform arithmetic operation based on arithmetic results thereof.

### Functional Configuration

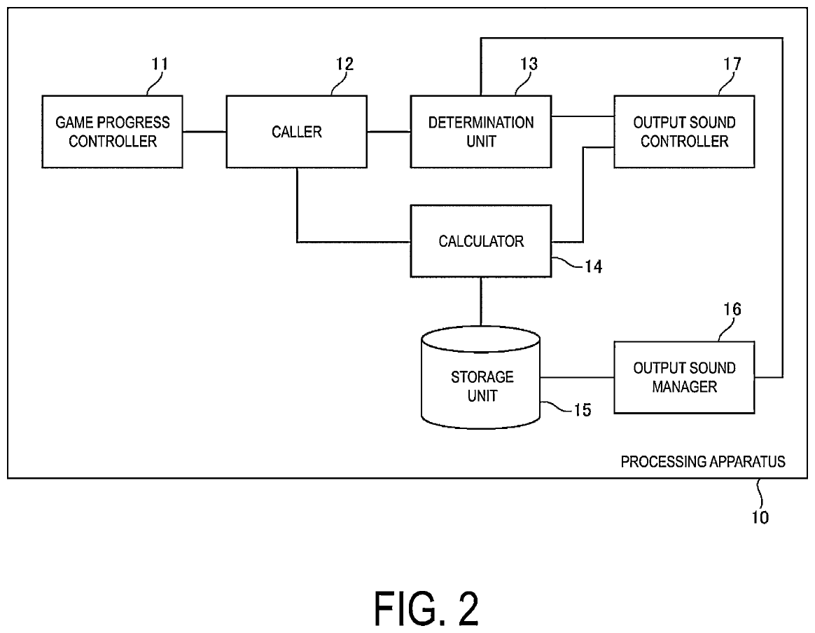

Next, a functional configuration of the processing apparatus 10 of the present embodiment will be described in detail. FIG. 2 illustrates an example of a functional block diagram of the processing apparatus 10. As illustrated in the figure, the processing apparatus 10 includes a game progress controller 11, a caller 12, a determination unit 13, a calculator 14, a storage unit 15, an output sound manager 16, and an output sound controller 17.

The game progress controller 11 controls progress of a game, based on a user input. For example, the game progress controller 11 starts the game, pauses the game, ends the game, and saves the game, for example, based on the user input. The game progress controller 11 performs the transition of a menu screen, based on the user input. The game progress controller 11 causes the game to progress, based on the user input received during the game. Details of the user input received from the user during the game are defined for each game in advance. For example, examples include a user input to move a character, a user input to attack an enemy character, and a user input to defend, but are not limited thereto. Based on these user inputs, the game progress controller 11 moves the character in a predetermined direction, calculates the amount of damage done to the enemy character, and calculates damage received by the character of the user. Details of control on the progress of the game performed by the game progress controller 11 are matters of design, and can be determined for each game.

When a phenomenon (hereinafter an “output sound phenomenon”) for outputting a predetermined output sound occurs during the control of the progress of the game as described above, the game progress controller 11 inputs information (hereinafter “notification information”) indicating that a predetermined output sound phenomenon has occurred to the caller 12.

Multiple output sound phenomena and output sounds output according to occurrence of respective output sound phenomena can be defined for each game in advance. For example, start of the game, pause of the game, end of the game, save of the game, transition of the menu screen, an attack, defense, movement, death of the enemy character, recovery of hit points, and the like can be the output sound phenomena. Suitable output sounds can be output according to occurrence of respective output sound phenomena. Note that the examples given herein are merely examples, and are not limited thereto. The notification information input from the game progress controller 11 to the caller 12 indicates which output sound phenomenon has occurred.

When the caller 12 receives the notification information from the game progress controller 11, the caller 12 calls an event to be executed according to the output sound phenomenon indicated by the notification information. Multiple events are defined in advance. In each event, details of output sound control are specified. For example, control of generating a new output sound, stopping an output sound being output, and adjusting the volume of the output sound being output is specified in each event.

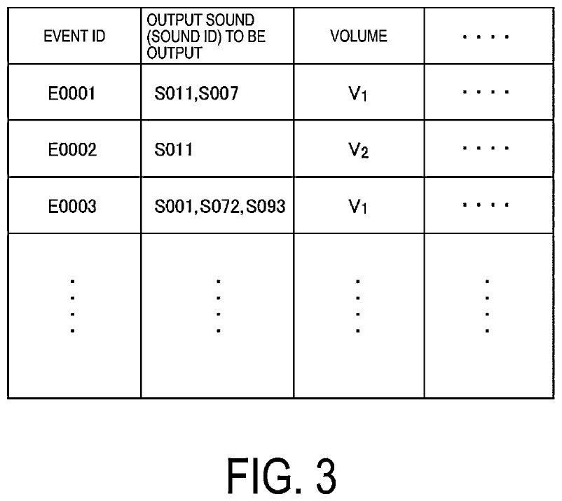

For example, multiple events are defined as illustrated in FIG. 3. In FIG. 3, the details of output sound control are specified for each event (for each event identifier (ID)). In the column of “output sound (sound ID) to be output”, an output sound to be newly generated is defined in each event. In the column of “volume”, the volume of the output sound to be newly generated is defined. For example, with event ID “E0001”, newly generating a sound of S011 and a sound of S007 at volume V1 is defined.

Note that, as illustrated in the figure, the output sound(s) to be generated in each event include one or multiple sounds. The multiple sounds include various sounds, such as a “sound of a blow”, a “sound of rustling of clothes”, “background music (BGM) 1”, “background music (BGM) 2”, a “sound of wind”, a “sound of a landslip”, and a “walking sound”. The sound IDs starting with “S” illustrated are information for identifying the multiple sounds from each other.

In FIG. 3, only control of generating new output sound(s) corresponding to each event is specified, but details of control of stopping an output sound being output and control of adjusting the volume of the output sound being output may be specified.

Each of multiple output sound generating phenomena is associated with a corresponding one of multiple events in advance. The caller 12 calls an event associated with the output sound generating phenomenon indicated by the notification information received from the game progress controller 11.

Referring back to FIG. 2, the determination unit 13 determines the output sound(s) to be newly output, based on the event called by the caller 12. As described above, in each event, the details of output sound control are specified. The determination unit 13 determines the output sound to be newly output, based on the details defined in each event.

The calculator 14 calculates details of volume adjustment to be performed for each of the output sounds being output at the current time point, based on the event called by the caller 12. In each event, the details of volume adjustment to be performed for each of the output sounds being output at the current time point are specified. The calculator 14 calculates the details of volume adjustment to be performed for each of the output sounds being output at the current time point, based on the details defined in each event.

For example, the calculator 14 can determine the decrease amount of the volume of each of the output sounds being output at the current time point, based on a time difference between an output start timing of each of the output sounds being output at the current time point and the current time point. A calculation method for the decrease amount is specified for each event in advance.

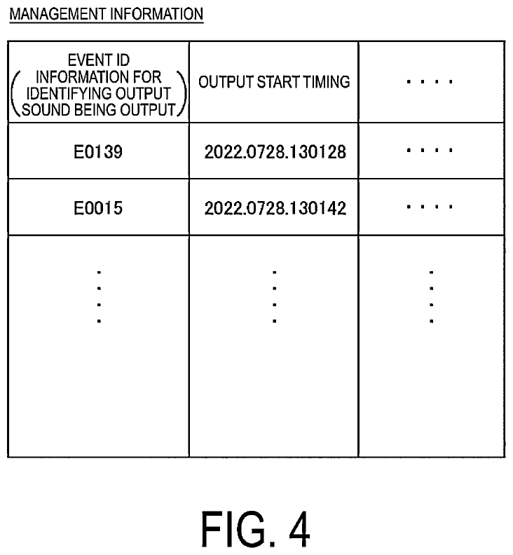

First, a means for specifying the output sound being output and a means for calculating the time difference will be described. In the present embodiment, the storage unit 15 stores management information as illustrated in FIG. 4. In the management information illustrated in the figure, the event IDs and the output start timings are associated with each other.

The event IDs are information for identifying the multiple events, and in the present embodiment, the event IDs are used as identification information for identifying the output sounds being output at the current time point. As described above, a predetermined output sound is output in response to execution of a predetermined event. Thus, the event IDs can be used as identification information for identifying the output sounds being output at the current time point. As a modified example, output sound IDs for identifying multiple output sounds from each other may be defined, and output sound IDs may be used in place of the event IDs in the management information illustrated in the figure.

The output start timing indicates a timing at which output of each output sound is started. In the illustrated example, the output start timing is indicated using information of the year, the month, the day, and the time, but the output start timing may be indicated using other information. For example, the output start timing may be indicated using relative time based on a CPU clock. In this case, with use of a relative time from a boot of hardware executing a game program, a time difference (a difference between the output start timing of each output sound and the current time point) can be calculated in milliseconds. Moreover, the number of frames having elapsed since start of the game may be stored, and a time difference (a difference between the output start timing of each output sound and the current time point) may be calculated based on the number of frames having elapsed at the output start timing. Note that there may be various timings to be registered with the management information as the output start timing. For example, examples include a timing at which an event is called and a timing at which output of an output sound is actually started, but are not limited thereto.

The calculator 14 specifies the output sounds being output at the current time point, based on such management information. The calculator 14 calculates the difference between the output start timing of each output sound and the current time point as the time difference.

Next, description will be given of processing of calculating the details of volume adjustment to be performed for each of the output sounds being output at the current time point based on the time difference between the output start timing of each of the output sounds being output at the current time point and the current time point (hereinafter simply referred to as the “time difference”).

In the present embodiment, a method of calculating the details of volume adjustment to be executed is specified for each event in advance. In the present embodiment, as a detail of volume adjustment, the “decrease amount of the volume” is calculated. In the present embodiment, as a detail of volume adjustment, a “method of restoring the decreased volume” may be further calculated. These calculation methods may be different for each event.

First, processing of calculating the decrease amount of the volume will be described. The calculator 14 determines the decrease amount of the volume, based on the time difference. The calculator 14 determines a larger decrease amount of the volume as the time difference increases. When the time difference is 0, the calculator 14 determines 0 as the decrease amount of the volume.

The determination of the decrease amount of the volume according to the time difference as described above may be implemented, for example, through arithmetic operation using a predetermined function (a function of calculating the decrease amount of the volume based on the time difference). The function may be an N-th degree function (N is an integer of 1 or greater), may be a trigonometric function, or may be another function. Moreover, a table in which the time difference and the decrease amount of the volume are associated with each other may be prepared in advance. The decrease amount of the volume according to the time difference may be determined based on the table.

The method of calculating the decrease amount of the volume (the calculation method of calculating the details of volume adjustment) can be defined for each event. For example, a linear function may be employed in one event, and a quadratic function may be employed in another event. Linear functions may be employed in multiple events and slopes thereof may be different from each other.

Note that, when a linear function is employed, a “maximum decrease amount” and a “time difference for the maximum decrease amount” may be defined for each event. The slope of the linear function is obtained for each event, based on these pieces of information. In a case of the present example, the maximum decrease amount may be applied to the time difference that is equal to or larger than the time difference corresponding to the maximum decrease amount.

Next, processing of calculating the method of restoring from the decreased volume will be described. As the method of restoring from the decreased volume, examples include a “method of gradually restoring to the original volume over a predetermined time” and a “method of restoring to the original volume after an elapse of a predetermined time since decrease of the volume”. Note that the decreased volume may be restored to the original volume using another method.

The method of restoring to the decreased volume may be different for each event. For example, the “method of gradually restoring to the original volume over a predetermined time” may be employed in one event, and the “method of restoring to the original volume after an elapse of a predetermined time since decrease of the volume” may be employed in another event. The “method of gradually restoring to the original volume over a predetermined time” may be employed in multiple events and the predetermined times may be different from each other. The “method of restoring to the original volume after an elapse of a predetermined time since decrease of the volume” may be employed in multiple events and the predetermined times may be different from each other. In other words, the “predetermined time for restoring the decreased volume to the original volume” may be determined for each event.

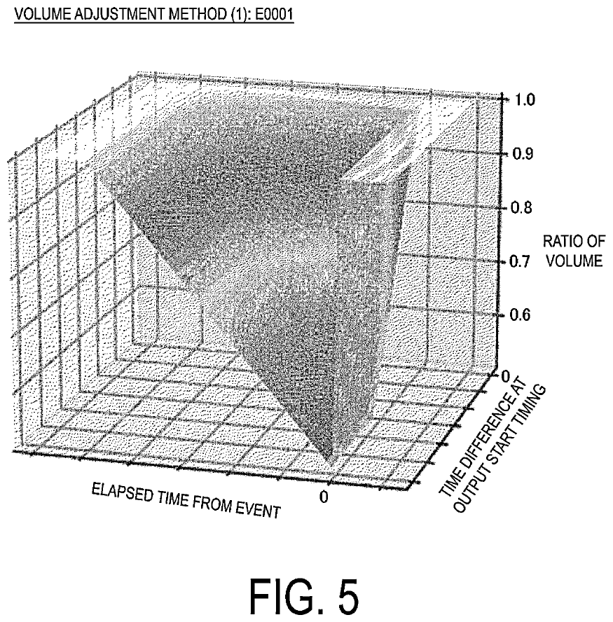

Here, a specific example of processing of determining the details of volume adjustment will be described. In the example, as illustrated in FIG. 5, a volume adjustment method is defined for each event in advance. Information illustrated in FIG. 5 indicates the volume adjustment method executed in an event identified by event ID “E0001”. The illustrated graph has axes of a “time difference at the output start timing”, “elapsed time from the event”, and a “ratio of the volume”.

The “time difference at the output start timing” indicates the time difference between the output start timing of each of the output sounds being output at the time point at which the event identified by event ID “E0001” is called and the current time point.

The “elapsed time from the event” indicates the elapsed time from the time point at which the event identified by event ID “E0001” is called. The “time point at which the event identified by event ID “E0001” is called” may be replaced with another timing being close thereto. For example, it may be replaced with a time point at which the volume of the output sound being output at this time point is actually decreased based on the event.

The “ratio of the volume” indicates the decrease amount of the volume of the output sound being output, the ratio of the volume being a ratio of the decreased volume of the output sound being output to the volume at the time point when volume adjustment (decrease) is not executed being “1”.

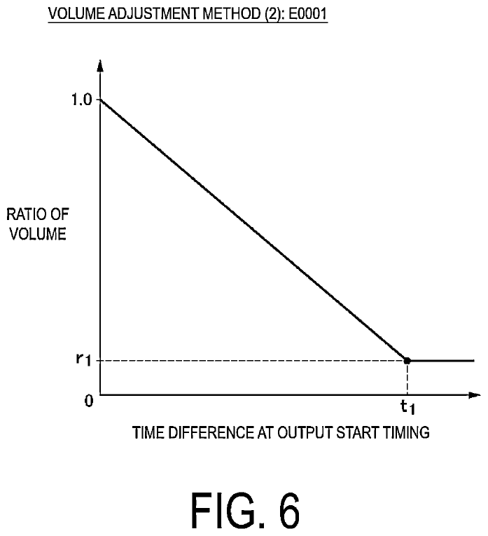

FIG. 6 illustrates an example in which the information of FIG. 5 is illustrated with two axes of the “time difference at the output start timing” and the “ratio of the volume”. The horizontal axis represents the “time difference at the output start timing”, and the vertical axis represents the “ratio of the volume”. The graph illustrates the calculation method for the “decrease amount of the volume”. The illustrated example illustrates that, the larger the time difference between the output start timing and the current time point is, the lower the ratio of the volume is, that is, the larger the decrease amount of the volume is. It illustrates that, when the time difference between the output start timing and the current time point is 0, the decrease amount of the volume is 0 (the ratio of the volume “1.0”). r₁ in the figure is the “maximum decrease amount” described above, and t₁ is the “time difference for the maximum decrease amount” described above.

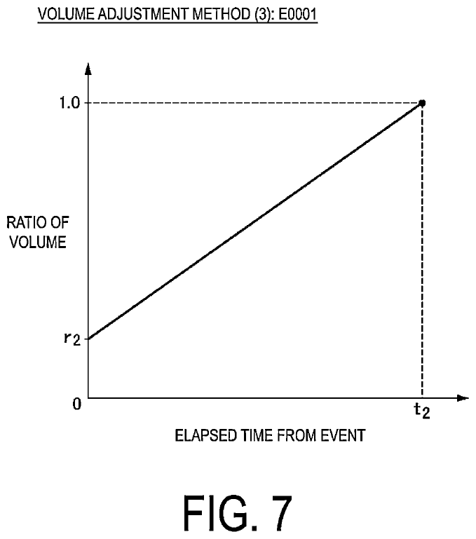

Next, FIG. 7 illustrates an example in which the information of FIG. 5 is illustrated with two axes of the “elapsed time from the event” and the “ratio of the volume”. The horizontal axis represents the “elapsed time from the event”, and the vertical axis represents the “ratio of the volume”. The graph illustrates the “method of restoring the decreased volume”. r₂ in the figure is the decrease amount determined based on the “time difference between the output start timing and the current time point”. It illustrates that the volume of the output sound being output is decreased down to the determined decrease amount along with execution of the event. It illustrates that the volume is gradually restored to the original volume (the ratio of the volume “1.0”) over a time t₂ afterwards. t₂ is the “predetermined time for restoring from the decreased volume to the original volume” described above. Note that, in FIG. 7, the method of restoring the volume using a linear function is defined, but the method of restoring the volume using another function may be defined.

Referring back to FIG. 2, the output sound controller 17 outputs the output sound determined to be newly output, and adjusts the volume of each of the output sounds being output at the current time point, based on the calculated details of volume adjustment. Specifically, the output sound controller 17 decreases the volume of each of the output sounds being output at the current time point, based on the calculated details of volume adjustment. The output sound controller 17 can restore the decreased volume to the original volume, based on the calculated details of volume adjustment.

The output sound manager 16 manages the management information (see FIG. 4) stored in the storage unit 15. In other words, the output sound manager 16 adds new information to the management information and deletes information from the management information. Specifically, the output sound manager 16 registers the identification information (e.g., the event ID) and the output start timing of the output sound determined to be newly output with the management information. When output of the output sound being output is stopped, in response to the stop, the output sound manager 16 deletes the identification information (e.g., the event ID) and the output start timing of the output sound from the management information. The stop of output of the output sound being output is implemented, for example, in response to execution of a predetermined event or in response to an elapse of a predetermined time from the output start timing, but is not limited thereto.

Note that the functions of the caller 12, the determination unit 13, the calculator 14, the storage unit 15, and the output sound manager 16 can be implemented, for example, using middleware such as Wwise.

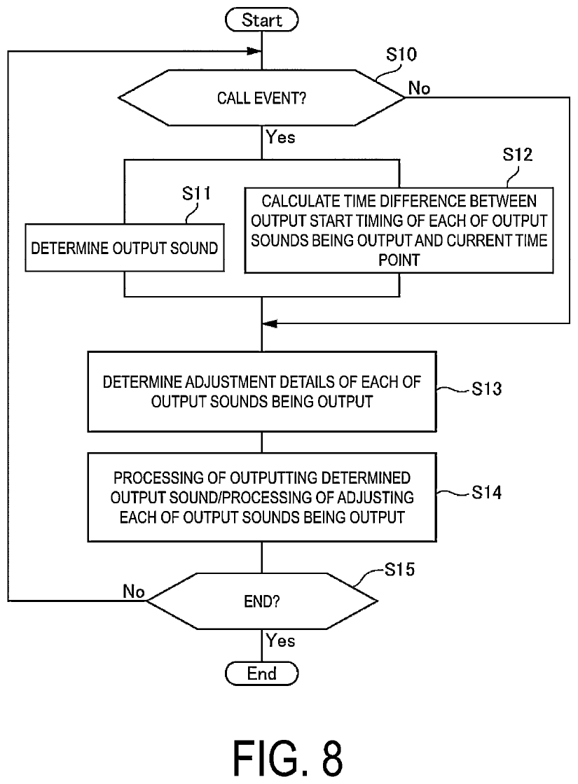

Next, an example of a flow of processing of the processing apparatus 10 will be described with reference to the flowchart of FIG. 8. Here, an example of processing of controlling the output sound implemented by the caller 12, the determination unit 13, the calculator 14, the storage unit 15, and the output sound manager 16 will be described.

The caller 12 is in a state of waiting for the notification information output from the game progress controller 11. The caller 12 determines whether or not the notification information has been input. In the present embodiment, the caller 12 determines whether or not the notification information has been input for each frame while not limited thereto. The determination may be performed at another timing. When the notification information is input, in response to reception of the notification information, the caller 12 calls an event associated with the output sound generating phenomenon indicated by the received notification information (Yes in S10). Subsequently, processing of S11 to S14 is executed. On the other hand, when the notification information is not input, the caller 12 does not call an event (No in S10). Subsequently, processing of S11 and S12 is not executed, and processing of S13 and S14 is executed.

When an event is called (Yes in S10), processing specified by the called event is executed. Here, the determination unit 13 determines the output sound to be newly output, based on the called event (S11). The calculator 14 calculates details of volume adjustment to be performed for each of the output sounds being output at the current time point, based on the called event. Specifically, the calculator 14 calculates the time difference between the output start timing of each of the output sounds being output at the current time point and the current time point (S12), and determines the decrease amount of the volume of each of the output sounds being output, based on the calculated time difference (S13).

Then, the output sound manager 16 outputs the output sound determined to be newly output in S11, and adjusts the volume of each of the output sounds being output at the current time point, based on the details of volume adjustment (decrease amount) calculated in S13 (S14).

When an event is not called (No in S10), the processing apparatus 10 determines adjustment details of the output sounds being output at the current time point, using any means (S13). Then, the output sound manager 16 adjusts each of the output sounds being output at the current time point, based on the adjustment details determined in S13 (S14). Adjustment of the output sound herein is volume adjustment (increase or decrease of the volume), but is not limited thereto. For example, in S13, whether the volume is increased or decreased, whether the volume is caused to remain unchanged, the increase amount when the volume is increased and the decrease amount when the volume is decreased, and the like are determined.

The processing apparatus 10 repeatedly executes processing of S10 to S15 illustrated in FIG. 8. The processing apparatus 10 can, for example, perform the processing of S10 to S15 illustrated in FIG. 8 for each frame.

### Effects

When the processing apparatus 10 of the present embodiment outputs a new output sound, the processing apparatus 10 decreases the volume of the output sounds being output at this time point. Then, the processing apparatus 10 determines the decrease amount of the volume, based on the time difference between the output start timing of each of the output sounds and the current time point. Specifically, the processing apparatus 10 determines a larger decrease amount as the time difference increases. In other words, a larger decrease amount is determined as the output start timing is farther from the current time point, and a smaller decrease amount is determined as the output start timing is closer to the current time point.

Through such processing, an output sound whose output start timing is closer to the current time point is output at larger volume. As a result, “control of accentuating a more important output sound, that is, an output sound whose output start timing is closer to the current time point, when multiple output sounds are simultaneously output” can be performed.

When the time difference between the output start timing and the current time point is 0, the processing apparatus 10 can calculate 0 as the decrease amount. This can avoid an inconvenience of decrease of the volume of another new output sound based on one new output sound when, for example, output of multiple new output sounds is simultaneously started.

The processing apparatus 10 can make the calculation methods for the decrease amount of the volume different for each event (that is, for each output sound to be newly output). This enables, for example, control of, in a case of newly outputting a more important output sound, decreasing to a greater extent the volume of the output sounds being output at this time point, and the like.

### Second Embodiment

In the first embodiment, the details of volume adjustment calculated based on the time difference between the output start timing and the current time point is the “decrease amount of the volume of the output sounds being output at the current time point”. In the present embodiment, the details of volume adjustment calculated based on the time difference between the output start timing and the current time point is a “cutoff frequency of a low-pass filter applied to the output sounds being output at the current time point”. In this respect, the processing apparatus 10 of the present embodiment is different from the processing apparatus 10 of the first embodiment. Details will be described below.

Similarly to the first embodiment, based on the event called by the caller 12, the calculator 14 calculates the details of volume adjustment to be performed for each of the output sounds being output at the current time point, based on the time difference between the output start timing of each of the output sounds being output at the current time point and the current time point.

In the first embodiment, the calculator 14 calculates the decrease amount of the volume of each of the output sounds being output at the current time point, based on the time difference. In the present embodiment, the calculator 14 calculates the cutoff frequency of the low-pass filter applied to the output sounds being output at the current time point, based on the time difference. The calculator 14 calculates a lower cutoff frequency as the time difference increases.

For example, a graph is prepared for each event in advance, the graph being obtained by replacing the axis of the “ratio of the volume” with the “cutoff frequency of the low-pass filter” in the graph as illustrated in FIG. 5. The calculator 14 calculates the cutoff frequency of the low-pass filter applied to the output sounds being output at the current time point and a restoration method of restoring the cutoff frequency to the original state, based on the graph. These calculation methods may be different for each event.

Other configuration of the processing apparatus 10 of the present embodiment is similar to the configuration of the processing apparatus 10 of the first embodiment.

According to the processing apparatus 10 of the present embodiment, effects similar to those of the first embodiment are implemented.

### Third Embodiment

As has been described with reference to FIG. 5 and FIG. 7, adjustment (adjustment of the volume, adjustment of the cutoff frequency of the low-pass filter) of the output sounds being output at this time point (current time point) continues for a predetermined time, the adjustment being performed according to output of a new output sound. Thus, there may be a situation in which another new second output sound is output during continuation of the adjustment performed according to output of a new first output sound. The processing apparatus 10 of the present embodiment includes a means for appropriately adjusting the output sounds being output in such a situation. Details will be described below.

The output sound controller 17 performs control of adjusting each of the output sounds being output at the current time point according to output of a new output sound, based on the details of volume adjustment calculated by the calculator 14. Then, as has been described with reference to FIG. 5 and FIG. 7, the output sound controller 17 continues the control up to a time point at which a predetermined time has elapsed since a time point at which the control is started, and cancels the control after the predetermined time has elapsed. FIG. 7 illustrates that the control of the output sounds being output at the current time point is performed for a predetermined time t₂.

The output sound controller 17 includes a means for appropriately adjusting the output sounds being output when there is a situation in which another new second output sound is output during continuation of the adjustment performed according to output of a new first output sound. The means will be described below separately for a case in which the calculator 14 calculates the decrease amount of the volume based on the time difference and a case in which the calculator 14 calculates the cutoff frequency of the low-pass filter based on the time difference.

### Case of Determining Decrease Amount of Volume Based on Time Difference

### Processing Example 1

When the output sound controller 17 performs control based on a second event during continuation of control (adjustment of the output sounds being output) based on a first event, the output sound controller 17 employs a larger one of the decrease amount at the current time point (a time point at which the second event is called) calculated based on the first event and the decrease amount at the current time point (a time point at which the second event is called) calculated based on the second event, as the decrease amount of the volume of each of the output sounds being output at the current time point (a time point at which the second event is called).

### Processing Example 2

When the output sound controller 17 performs control based on a second event during continuation of control (adjustment of the output sounds being output) based on a first event, the output sound controller 17 employs the decrease amount obtained by adding the decrease amount at the current time point (a time point at which the second event is called) calculated based on the second event to the decrease amount at the current time point (a time point at which the second event is called) calculated based on the first event, as the decrease amount of the volume of each of the output sounds being output at the current time point (a time point at which the second event is called).

### Case of Calculating Cutoff Frequency of Low-Pass Filter Based on Time Difference

### Processing Example 1

When the output sound controller 17 performs control based on a second event during continuation of control (adjustment of the output sounds being output) based on a first event, the output sound controller 17 employs a lower one of the cutoff frequency at the current time point (a time point at which the second event is called) calculated based on the first event and the cutoff frequency at the current time point (a time point at which the second event is called) calculated based on the second event, as the cutoff frequency of the low-pass filter applied to each of the output sounds being output at the current time point (a time point at which the second event is called).

### Processing Example 2

When the output sound controller 17 performs control based on a second event during continuation of control (adjustment of the output sounds being output) based on a first event, the output sound controller 17 employs a value obtained by subtracting, from the original cutoff frequency, the decrease amount obtained by adding the decrease amount of the cutoff frequency at the current time point (a time point at which the second event is called) calculated based on the second event to the decrease amount (a difference between the original cutoff frequency and the cutoff frequency at the current time point) of the cutoff frequency at the current time point (a time point at which the second event is called) calculated based on the first event, as the cutoff frequency of the low-pass filter applied to each of the output sounds being output at the current time point (a time point at which the second event is called).

Other configuration of the processing apparatus 10 of the present embodiment is similar to the configuration of the processing apparatus 10 of the first and second embodiments.

According to the processing apparatus 10 of the present embodiment, effects similar to those of the first and second embodiments are implemented. According to the processing apparatus 10, in a situation in which another new second output sound is output during continuation of adjustment of the output sounds being output which is performed according to output of a new first output sound, the output sounds being output can be appropriately adjusted.

### Modified Examples

Here, modified examples that can be applied to all the embodiments will be described.

In the above embodiments, the volume is determined for each event as illustrated in FIG. 3. As a modified example, in addition to the volume for each event, the volume may further be determined for each output sound (sound ID) associated with the event ID. In outputting, respective volume parameters may be multiplied (calculated) to determine the volume. For example, when the volume parameter associated with a certain event ID is 0.9 and the volume parameter associated with the sound ID associated with the event ID is 0.8, the volume to be output is 0.72 (=0.9×0.8). The volume adjustment control performed by the calculator 14 and the output sound controller 17 described in the above embodiments is performed on the volume parameter associated with the event ID.

While the embodiments of the present invention have been described in the above with reference to the drawings, these are examples of the present invention, and various configurations other than the above can also be employed. The configurations of the embodiments described above may be combined with each other, or a part of the configurations may be replaced with another configuration. Various modifications may be made to the configurations of the embodiments described above within the scope of not departing from the gist. The configurations and the processes disclosed in the embodiments and the modified examples described above may be combined with each other.

In the flowchart used in the description above, order of multiple steps (processes) is described, but the order of executing the steps executed in the embodiments is not limited to the order in the description. In the embodiments, the order of steps illustrated in the drawings can be changed as long as there is no problem in the details. The embodiments described above can be combined as long as the details are not inconsistent with each other.

The whole or part of the embodiments described above can be described as, but not limited to, the following supplementary notes.

1. A program causing a computer to function as:
an output sound manager configured to manage management information in which identification information for identifying one or multiple output sounds being output at a current time point and information indicating an output start timing of each of the one or multiple output sounds are associated with each other;
a caller configured to call an event of controlling the output sound;
a determination unit configured to, based on the event, determine the output sound to be newly output;
a calculator configured to, based on the event, calculate details of volume adjustment to be performed for each of the one or multiple output sounds being output at the current time point, based on a time difference between the output start timing of each of the one or multiple output sounds being output at the current time point and the current time point; and
an output sound controller configured to output the output sound determined to be newly output, and adjust each of the one or multiple output sounds being output at the current time point, based on the calculated details of the volume adjustment.

2. The program according to 1, wherein
the output sound manager registers the identification information and the output start timing of the output sound determined to be newly output with the management information.

3. The program according to 1 or 2, wherein
the calculator calculates a decrease amount of the volume, based on the time difference, and
the calculator calculates a larger decrease amount as the time difference increases.

4. The program according to 3, wherein
when the time difference is 0, the calculator calculates 0 as the decrease amount.

5. The program according to 1 or 2, wherein
the calculator calculates a cutoff frequency of a low-pass filter applied to the output sound, based on the time difference, and
the calculator calculates a lower cutoff frequency as the time difference increases.

6. The program according to any one of 1 to 5, wherein
a method of calculating the details of the volume adjustment is different for each event.

7. The program according to any one of 1 to 6, wherein
the output sound controller continues control of adjusting each of the one or multiple output sounds being output at the current time point based on the details of the volume adjustment up to a time point at which a predetermined time has elapsed since a time point at which the control is started, and cancels the control after the predetermined time has elapsed.

8. The program according to 7, wherein
the calculator calculates a decrease amount of the volume, based on the time difference, and
when the output sound controller performs the control based on a second event during continuation of the control based on a first event, the output sound controller employs a larger one of the decrease amount calculated based on the first event and the decrease amount calculated based on the second event, as the decrease amount of the volume of each of the one or multiple output sounds being output at the current time point.

9. The program according to 7, wherein
the calculator calculates a cutoff frequency of a low-pass filter applied to the output sound, based on the time difference, and
when the output sound controller performs the control based on a second event during continuation of the control based on a first event, the output sound controller employs a lower one of the cutoff frequency calculated based on the first event and the cutoff frequency calculated based on the second event, as the cutoff frequency of the low-pass filter applied to each of the one or multiple output sounds being output at the current time point.

10. A processing apparatus including:
an output sound manager configured to manage management information in which identification information for identifying one or multiple output sounds being output at a current time point and information indicating an output start timing of each of the one or multiple output sounds are associated with each other;
a caller configured to call an event of controlling the output sound;
a determination unit configured to, based on the event, determine the output sound to be newly output;
a calculator configured to, based on the event, calculate details of volume adjustment to be performed for each of the one or multiple output sounds being output at the current time point, based on a time difference between the output start timing of each of the one or multiple output sounds being output at the current time point and the current time point; and
an output sound controller configured to output the output sound determined to be newly output, and adjust each of the one or multiple output sounds being output at the current time point, based on the calculated details of the volume adjustment.

11. A processing method performed by one or more computers, the processing method including:
managing management information in which identification information for identifying one or multiple output sounds being output at a current time point and information indicating an output start timing of each of the one or multiple output sounds are associated with each other;
calling an event of controlling the output sound;
based on the event, determining the output sound to be newly output;
based on the event, calculating details of volume adjustment to be performed for each of the one or multiple output sounds being output at the current time point, based on a time difference between the output start timing of each of the one or multiple output sounds being output at the current time point and the current time point; and
outputting the output sound determined to be newly output, and adjusting each of the one or multiple output sounds being output at the current time point, based on the calculated details of the volume adjustment.

This application claims priority based on JP 2022-157621 filed on Sep. 30, 2022, the entire disclosure of which is incorporated by reference herein.

### REFERENCE SIGNS LIST

10 Processing apparatus
11 Game progress controller
12 Caller
13 Determination unit
14 Calculator
15 Storage unit
16 Output sound manager
17 Output sound controller
1A Processor
2A Memory
3A Input/output I/F
4A Peripheral circuit
5A Bus

What is claimed is:

1. A program causing a computer to function as:
an output sound manager configured to manage management information in which identification information for identifying one or multiple output sounds being output at a current time point and information indicating an output start timing of each of the one or multiple output sounds are associated with each other;
a caller configured to call an event of controlling the output sound;
a determination unit configured to, based on the event, determine the output sound to be newly output;
a calculator configured to, based on the event, calculate details of volume adjustment to be performed for each of the one or multiple output sounds being output at the current time point, based on a time difference between the output start timing of each of the one or multiple output sounds being output at the current time point and the current time point; and
an output sound controller configured to output the output sound determined to be newly output, and adjust each of the one or multiple output sounds being output at the current time point, based on the calculated details of the volume adjustment.

2. The program according to claim 1, wherein
the output sound manager registers the identification information and the output start timing of the output sound determined to be newly output with the management information.

3. The program according to claim 1, wherein
the calculator calculates a decrease amount of the volume, based on the time difference, and
the calculator calculates a larger decrease amount as the time difference increases.

4. The program according to claim 3, wherein
when the time difference is 0, the calculator calculates 0 as the decrease amount.

5. The program according to claim 1, wherein
the calculator calculates a cutoff frequency of a low-pass filter applied to the output sound, based on the time difference, and
the calculator calculates a lower cutoff frequency as the time difference increases.

6. The program according to claim 1, wherein
a method of calculating the details of the volume adjustment is different for each event.

7. The program according to claim 1, wherein
the output sound controller continues control of adjusting each of the one or multiple output sounds being output at the current time point based on the details of the volume adjustment up to a time point at which a predetermined time has elapsed since a time point at which the control is started, and cancels the control after the predetermined time has elapsed.

8. The program according to claim 7, wherein
the calculator calculates a decrease amount of the volume, based on the time difference, and
when the output sound controller performs the control based on a second event during continuation of the control based on a first event, the output sound controller employs a larger one of the decrease amount calculated based on the first event and the decrease amount calculated based on the second event, as the decrease amount of the volume of each of the one or multiple output sounds being output at the current time point.

9. The program according to claim 7, wherein
the calculator calculates a cutoff frequency of a low-pass filter applied to the output sound, based on the time difference, and
when the output sound controller performs the control based on a second event during continuation of the control based on a first event, the output sound controller employs a lower one of the cutoff frequency calculated based on the first event and the cutoff frequency calculated based on the second event, as the cutoff frequency of the low-pass filter applied to each of the one or multiple output sounds being output at the current time point.

10. A processing apparatus comprising:
an output sound manager configured to manage management information in which identification information for identifying one or multiple output sounds being output at a current time point and information indicating an output start timing of each of the one or multiple output sounds are associated with each other;
a caller configured to call an event of controlling the output sound;
a determination unit configured to, based on the event, determine the output sound to be newly output;
a calculator configured to, based on the event, calculate details of volume adjustment to be performed for each of the one or multiple output sounds being output at the current time point, based on a time difference between the output start timing of each of the one or multiple output sounds being output at the current time point and the current time point; and
an output sound controller configured to output the output sound determined to be newly output, and adjust each of the one or multiple output sounds being output at the current time point, based on the calculated details of the volume adjustment.

11. A processing method performed by one or more computers, the processing method comprising:
managing management information in which identification information for identifying one or multiple output sounds being output at a current time point and information indicating an output start timing of each of the one or multiple output sounds are associated with each other;
calling an event of controlling the output sound;
based on the event, determining the output sound to be newly output;
based on the event, calculating details of volume adjustment to be performed for each of the one or multiple output sounds being output at the current time point, based on a time difference between the output start timing of each of the one or multiple output sounds being output at the current time point and the current time point; and
outputting the output sound determined to be newly output, and adjusting each of the one or multiple output sounds being output at the current time point, based on the calculated details of the volume adjustment.
